(19) United States
(12) Patent Application Publication
(10) Pub. No.: US 2024/0328867 A1
(43) Pub. Date: Oct. 3, 2024

(54) TEMPERATURE SENSING AND REPORTING DRAIN PLUG

(71) Applicant: Spencer Sutlive, Duluth, GA (US)

(72) Inventor: Spencer Sutlive, Duluth, GA (US)

(21) Appl. No.: 18/129,391

(22) Filed: Mar. 31, 2023

(51) Int. Cl. G01K 1/14; G01K 1/024; G01K 3/14

(52) U.S. Cl. CPC G01K 1/14; G01K 1/024; G01K 3/14

(57) ABSTRACT

The invention consists of a temperature sensing and reporting drain plug. The drain plug, used in concert with a cooler or ice chest, allows for the measurement of both the internal and external ambient temperatures. The temperature difference between the two can provide useful information to users regarding the remaining time in which the ice within the thermally isolated environment is likely to maintain a preset temperature, especially if the thermal coefficient of the thermal isolation is known. The present invention may also allow for notifications to be sent to a user, should the internal temperature increase to an unsafe level, or should such a temperature rise become imminent. The device accomplishes this by utilizing two temperature probes facing in opposite directions, and which are paired with a port and, in come configurations, a display that allows for information to be transmitted or presented to users.

### CROSS-REFERENCE TO OTHER APPLICATIONS

This application does not claim the benefit of any U.S. provisional patent application or foreign filing under the PCT.

### BACKGROUND OF THE INVENTION

Ice chests are devices that utilize frozen substances, usually water, in order to decrease temperature within a thermally isolated area. As temperature exchange occurs, the frozen substances melt. In order to accommodate for ice melting, most ice chests utilize some form of drain plug. This plug or spicket, located at the base of the body of an ice chest or cooler, allows for a channel to be opened to drain away melted ice after use is complete. However, while the ice box is in use, the drain is plugged in order to keep the freezing cold water in, prevent the exchange of heat with the outside environment, and prevent leakage. The present invention consists of an improvement to the plugs used to stop up the drains in ice bearing thermally sealed containers such that it may gather useful data and report it to the user in order to increase both safety and utility.

### BRIEF SUMMARY OF THE INVENTION

The invention consists of a drain plug structure that houses a means for comparing ambient and internal temperature within a thermally isolated space. By using two probes, one that detects the temperature outside an isolated space, and a second that detects the temperature within the isolated space, the device detects two distinct temperature measurements. By connecting the device to a power source via a port, meaningful information may also be offloaded in the form of temperature data to a computing device. Furthermore, such a port may include a means to wireless and continually report the data to a computer or smart phone, allowing for active monitoring of the internal temperature and useful calculations in comparison to the external temperature.

### BRIEF DESCRIPTION OF THE DRAWINGS

FIG. 1 shows a cross section of the invention. A Drain Plug Structure (1) is used to house a series of useful sensors and ports. An Exterior Sensor (2) directed to the exterior of the Drain Plug Structure (1) such that it can accurately report the external temperature. A second Interior Sensor (3) is likewise used to detect the temperature within the controlled environment and is housed in the portion of the Drain Plug Structure (1) such that it can accurately report the internal temperature. Both the Exterior Sensor (2) and Interior Sensor (3) are connected to a Port (4) that can be used for data transfer and electrical power supply.

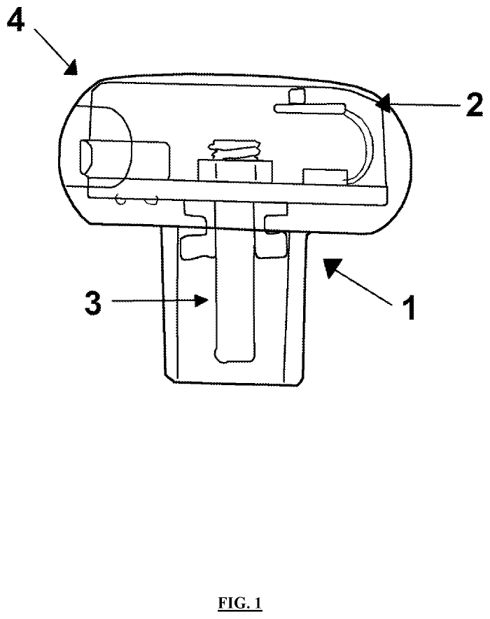

FIG. 2 shows an exterior view of the invention while the Port is connected. In this configuration, a Display (1) is affixed to the front of the Drain Plug Structure (2). On the side of the Drain Plug Structure (2) is a Cable (3), which is used to transfer power and data from the Port.

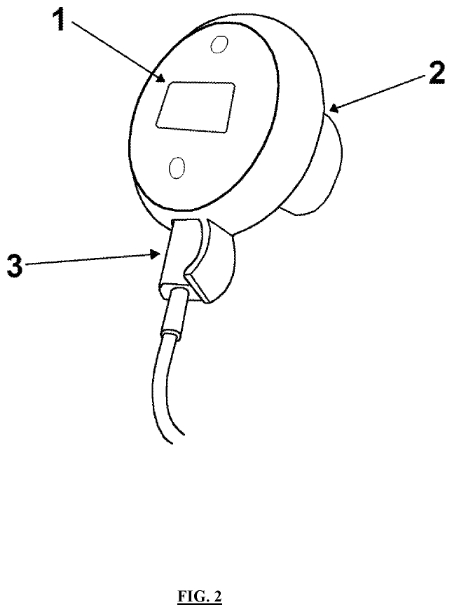

### DETAILED DESCRIPTION

The body of the plug is designed to universal manufacturing specifications, which are approximately one inch. A variety of different thread sizes, or threading alternatives such as rubber grommets, would also prove sufficient so long as they seal the interior of the isolated environment. Plugs are usually designed to both seal and insulate, thus there will be a significant difference between the outside and the inside temperatures at either end of the plug. This is especially true if the interior portion of a plug extends into the liquid within the isolated thermal environment, which is likely to provide an accurate reading of the general interior temperature. If the thermal retention of the storage box is known, a comparison of the inner temperature and the outer temperature should provide a means to predict the remaining time which the current supply of ice within the isolated environment will continue to maintain a set temperature.

In the present invention, the plug houses a series of sensors as well as a means for them to transmit data and receive power. In order to house the sensors, a portion of the plug is hollow, with a channel separating the exterior and interior surfaces being used to house the necessary components. Temperature sensors located on either side of the plug and facing in opposite directions make it possible to measure the interior and exterior temperatures and facilitate calculations and estimates derived from measuring the difference between them. In one implementation of the present invention, the interior temperature sensor embodies an elongated probe, allowing for protrusion into the interior environment. This facilitates a more accurate reading by increasing the distance between the interior and exterior temperature sensors as well as getting further into the center of the interior space of the ice box.

In addition to providing a means to provide power, the port also provides a means to communicate data with an enabled device. Such devices include but are not limited to smart phones, tablets, and computers. Such means of power delivery include but are not limited to USB, USB-C, USB Micro, Apple Lightning connector, or any technological and functional equivalent. This functionality is further supported by onboard power storage in the form of a capacitor or battery. The port may further include a means to communicate data wirelessly, such as but not limited to WiFi or Bluetooth broadband communications. A person having reasonable skill in the art will realize that there are a number of different specific implementations or variants of the components embodied within the present invention, and that this disclosure is entitled to capture functional equivalents for the disclosed mechanisms within the invention.

The invention may also include a way to transfer information, such as internal temperate or an estimate of the remaining time in which the desired internal temperature can be sustained, directly to the user. A screen or display may be mounted to the outside of the drain plug body to facilitate convenient and easy reference without the use of a separate device. In one iteration, the display may be a simple series of different colored lights, however another implementation of the invention may include a digital readout that provides more information in greater detail to the user. The invention may also include a means to insulate the display, the sensors, and the port from one another to prevent ambient temperature crossover and allow for more accurate measurements without the temperature data being disturbed by the opposite end of the plug or the functional elements housed within or upon the plug's surface.

1. A temperature sensing and reporting drain plug comprising:
a hollow body in a shape suitable for plugging a drain; and
an exterior temperature sensor directed to a portion of the hollow body that faces the exterior of the object being plugged and drained; and
an interior temperature sensor directed to a portion of the hollow body that faces the interior portion of the object being plugged and drained.

2. The drain plug of claim 1 further comprising a universal port capable of transmitting data that is connected to both the exterior temperature sensor and the interior temperature sensor.

3. The drain plug of claim 2 wherein the port contains a means of wireless information transmission.

4. The drain plug of claim 1 further comprising a visual display the transmits information gathered from the exterior temperature sensor and the interior temperature sensor.

5. A drain plug for the purpose of measuring differences in temperatures comprising:
a body containing at least one cavity; and
an exterior temperature sensor mounted on an exterior wall of the cavity such that it detects ambient temperature; and
an interior temperature sensor mounted on an interior wall of the cavity such that it detects internal temperature.

6. The drain plug of claim 5 further comprising a port for the purpose of providing data transfer and power to both the exterior temperature sensor and the interior temperature sensor.

7. The drain plug of claim 6 wherein the port contains a means of bilateral communication with an external digital device.

8. The drain plug of claim 7 further comprising a display for the purpose of communicating relevant information to a user.

9. A temperature measuring device comprising:
a body that functions as a drain plug; and
an exterior temperature sensor at one end of the body; and
an interior temperature sensor on another side of the body away from the exterior temperature sensor; and
a means for providing power and data transfers from the exterior sensor and the interior sensor.

10. The device of claim 9 which further comprises a means for wireless communication.

11. The device of claim 10 which further comprises a means for the storage of electricity.
